(19) United States
(12) Patent Application Publication
(10) Pub. No.: US 2026/0253570 A1
(43) Pub. Date: Aug. 27, 2026

(54) AN OPEN-AIR NOISE CANCELLATION SYSTEM AND A METHOD TO OPERATE THE SAME

(71) Applicants: Surya Sesha Sanathkumar Maddula, Bangalore (IN); Lakshmi Sujana Maddula, Bangalore (IN)

(72) Inventor: Surya Sesha Sanathkumar Maddula, Bangalore (IN)

(21) Appl. No.: 19/159,553

(22) PCT Filed: Apr. 24, 2024
(86) PCT No.: PCT/IB2024/053986

§ 371 Date: Aug. 25, 2025

(30) Foreign Application Priority Data
Feb. 24, 2023 (IN) 202341012752

(51) Int. Cl. G10K 11/178; G06F 3/16

(52) U.S. Cl. CPC G10K 11/17823; G06F 3/165; G10K 11/17873; G10K 2210/3011; G10K 2210/3027; G10K 2210/30351; G10K 2210/3048; G10K 2210/3056

(57) ABSTRACT

A noise cancellation system (100) is provided. The system includes a sound receiver module (102) positioned at a source (104) of external noise entry to receive a noise from an external uncontrolled noise source, a sound sensor (106) for recording the received noise, a noise model builder module (108) builds a plurality of artificial intelligence models based on a plurality of noise data definitions pre-stored in a database (110), an analysis module (114) classifies and analyse the recorded noise by using the plurality of artificial intelligence models and determine an intensity of the recorded noise, a sound wave releaser module (116) releases a series of counter sound waves and an amplitude, based on the amplitude of the noise and a user interface (118) detects a prolonged intermittent noise and enable a user to control the intensity of the noise cancellation and notifies noise signifying an emergency to the user.

### FIELD OF INVENTION

Embodiments of a present disclosure relate to the field of electronics, more particularly to a noise cancellation system and a method to operate the same.

### BACKGROUND

Many public places, homes, and corporate offices have open environments, in such places, environmental noise pollution has become a major problem. Common noise sources include roads and freeways, airplanes, industrial institutions, plants and factories, air conditioners, pool equipment, and the like. One of the drawbacks of open-office environments is that it is hard to work, or conduct calls in a noisy environment. The noise from the environment hinders the user's ability to hear the speaker. The noisy environment also hinders the user's ability to speak clearly over other noise sources.

Alternatively, the worker is forced to move to a quieter environment that does not have the noise elements. However, such spaces may be limited. Reducing environmental noise requires a noise reduction technique. Some noise control techniques such as earplugs, thick walls, and sound-absorbing ceiling tiles are undesirable for many situations. In situations where noise cancellation or suppression is desired as they can be uncomfortable, bulky, unsightly, or ineffective. However, prior active noise cancellation technologies are limited in applicability. They are suitable only for very small, enclosed spaces, such as headphones, or for continuous low-frequency sounds, such as machinery noise. Also, noise cancellation headphones cannot be used for new born babies or others who may be sensitive to noise but unable to wear a headphone for physical or medical reasons. Further, due in part to a dependency on complex signal processing algorithms, prior technologies are limited to actively cancelling noise that comprises a small range of predictable frequencies.

For these reasons, existing active cancellation techniques are ineffective in many situations where it is desirable to reduce noise. There is a need for a noise-cancelling system, which is not restricted to the ears and can be placed freely in the open, like a speaker. Also, there is a need for a system for noise cancellation which may be controlled, adjusted, and changed through a wireless system such as a mobile wherein the application is installed. Further, there is a need for a system which may not cancel the noise by identifying an emergency noise such as a smoke alarm.

Hence, there is a need for a noise cancellation system and a method to operate the same that addresses the aforementioned issues.

### BRIEF DESCRIPTION

In accordance with one embodiment of the disclosure, a noise cancellation system for cancelling noise by releasing sound waves to counter and nullify a path of sound particles is provided. The noise cancellation system includes a sound receiver module, a noise model builder module, an analysis module, a sound wave releaser module, and a user interface. The sound receiver module is positioned at a source of external noise entry and configured to receive a noise from an external uncontrolled noise source. The sound receiver module includes a sound sensor for recording the received noise from the external uncontrolled noise source. The noise model builder module is configured to build a plurality of artificial intelligence models based on a plurality of noise data definitions pre-stored in a database. The plurality of noise data definitions is a set of frequent noise recordings. The noise model builder module stores the plurality of artificial intelligence models back in a model repository. The analysis module is operatively coupled with the sound receiver module and the noise model builder module. The analysis module is configured to classify and analyse the recorded noise by using the plurality of artificial intelligence models. The analysis of the recorded noise includes comparing the noise with a plurality of sound wave data stored in the database and determine an intensity of a recorded noise based on the analysis of the plurality of sound wave data. The sound wave releaser module is operatively coupled with the analysis module. The sound wave releaser module is configured to release a series of counter sound waves and an amplitude, based on the amplitude of the noise recorded by the sound sensor thereby cancelling the noise received. The series of counter sound waves distort the path of movement of a plurality of noise sound particles. The user interface is operatively coupled with the analysis module and the sound wave releaser module. The user interface is configured to detect a prolonged intermittent noise and enable a user to control the intensity of the noise cancellation. The user interface is also configured to notify the user on detecting noise signifying an emergency.

In accordance with another embodiment, a method for operating a noise cancellation system is provided. The method includes receiving, by a sound receiver module, noise from an external uncontrolled noise source, and recording the received noise from the external uncontrolled noise source by a sound sensor. The method also includes building, by a noise model builder module, a plurality of artificial intelligence models on a plurality of noise data definitions pre-stored in a database, wherein the plurality of noise data definitions is a set of frequent noise recordings intelligence models. Further, the method includes storing, by a noise model builder module, the plurality of artificial intelligence models back in a model repository. Furthermore, the method includes analyzing, by an analysis module, the recorded noise by using the plurality of artificial intelligence models, wherein the analysis of the recorded noise comprises comparing the noise with a plurality of sound wave data stored in the database. Furthermore, the method includes determining, by the analysis module, an intensity of a recorded noise based on the analysis of the plurality of sound wave data. Furthermore, the method includes releasing, by a sound wave releaser module, a series of counter sound waves and an amplitude, based on the amplitude of the noise recorded by the sound sensor thereby cancelling the noise received, wherein the series of counter sound waves distort the path of movement of a plurality of noise sound particles. Furthermore, the method includes detecting, by a user interface, a prolonged intermittent noise and enabling a user to control the intensity of the noise cancellation. Furthermore, the method includes notifying, by the user interface, the user on detecting noise signifying an emergency.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a noise cancellation system in accordance with an embodiment of the present disclosure;

FIG. 2 is a block diagram representing another embodiment of the noise cancellation system of FIG. 1 in accordance with an embodiment of the present disclosure;

FIG. 3 is a block diagram representing an exemplary embodiment of an architecture of the noise cancellation system of FIG. 1 in accordance with an embodiment of the present disclosure;

FIG. 4a is a graphical representation of an exemplary embodiment of the distortion of the sound wave of FIG. 1 in accordance with an embodiment of the present disclosure;

FIG. 4b is a graph diagram representing an exemplary embodiment of the sound wave of FIG. 1 in accordance with an embodiment of the present disclosure;

FIG. 5 is a block diagram of a computer or a server for the noise cancellation system in accordance with an embodiment of the present disclosure; and

FIG. 6 is a flow charts representing steps involved in a method for the operation of the noise cancellation system.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a noise cancellation system for cancelling noise by releasing sound waves to distort a path of sound particles is provided. The noise cancellation system includes a sound receiver module is positioned at a source of external noise entry and configured to receive a noise from an external uncontrolled noise source. The sound receiver module includes a sound sensor for recording the received noise from the external uncontrolled noise source. A noise model builder module is configured to build a plurality of artificial intelligence models based on a plurality of noise data definitions pre-stored in a database. The plurality of noise data definitions is a set of frequent noise recordings. The noise model builder module stores the plurality of artificial intelligence models back in a model repository. An analysis module is operatively coupled with the sound receiver module and the noise model builder module. The analysis module is configured to classify and analyse the recorded noise by using the plurality of artificial intelligence models. The analysis of the recorded noise includes comparing the noise with a plurality of sound wave data stored in the database and determine an intensity of a recorded noise based on the analysis of the plurality of sound wave data. A sound wave releaser module and a user interface are operatively coupled with the analysis module. The sound wave releaser module is configured to release a series of counter sound waves and an amplitude, based on the amplitude of the noise recorded by the sound sensor thereby cancelling the noise received. The series of counter sound waves distort the path of movement of a plurality of noise sound particles. The user interface is operatively coupled with the analysis module and the sound wave releaser module. A user interface is configured to detect a prolonged intermittent noise and enable a user to control the intensity of the noise cancellation. The user interface is also configured to notify the user on detecting noise signifying an emergency.

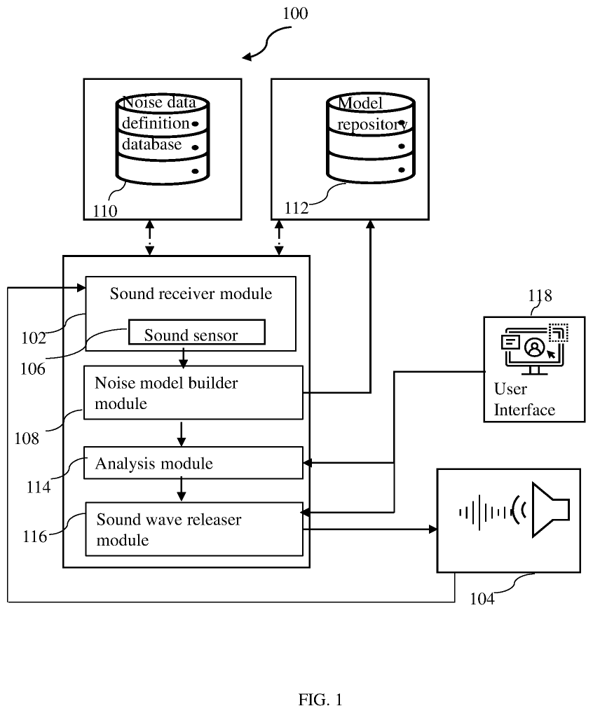

As used herein, the term “noise cancellation” denotes the reduce unwanted ambient sounds using active noise control. Further, the system described hereafter in FIG. 1 is a noise cancellation system and a method to operate the same.

FIG. 1 is a block diagram representing a noise cancellation system (100) in accordance with an embodiment of the present disclosure. The noise cancellation system (100) for cancelling noise by releasing sound waves to distort a path of sound particles. The noise cancellation system (100) includes a sound receiver module (102), a noise model builder module (108), an analysis module (114), a sound wave releaser module (116), and a user interface (118). The sound receiver module (102) positioned at a source (104) of external noise entry and configured to receive a noise from an external uncontrolled noise source (104). The sound receiver module (102) comprises a sound sensor (106) for recording the received noise from the external uncontrolled noise source (104).

The noise model builder module (108) is configured to build a plurality of artificial intelligence models based on a plurality of noise data definitions pre-stored in a database (110). The plurality of noise data definitions is a set of frequent noise recordings. The noise model builder module (108) stores the plurality of artificial intelligence models back in a model repository (112). In one embodiment, with the occurrences of the different noise data, the artificial intelligence updates the model repository (112).

The analysis module (114) is operatively coupled with the sound receiver module (102) and the noise model builder module (108). The analysis module (114) is configured to classify and analyse the recorded noise by using the plurality of artificial intelligence models. The analysis of the recorded noise includes comparing the noise with a plurality of sound wave data stored in the database (110). The analysis module (114) is configured to determine an intensity of a recorded noise based on the analysis of the plurality of sound wave data.

The sound wave releaser module (116) is operatively coupled with the analysis module (114), wherein the sound wave releaser module (116) is configured to release a series of counter sound waves and an amplitude, based on the amplitude of the noise recorded by the sound sensor (106) thereby cancelling the noise received, wherein the series of counter sound waves distort the path of movement of a plurality of noise sound particles. In one embodiment, the user may be able to reduce the external noise instead of cancelling the total noise using a mobile application interface.

The user interface (118) operatively coupled with the analysis module (114) and the sound wave releaser module (116). The user interface (118) is configured to detect a prolonged intermittent noise and enable a user to control the intensity of the noise cancellation. notify the user on detecting noise signifying an emergency. In one embodiment, the user interface (118) includes a mobile application interface.

In one embodiment, noise is recorded for future analysis and the noise recorded is stored in a central database and is subsequently used by the artificial intelligence model as a training set. In another embodiment, the recorded noise is stored in the user's local database. In one embodiment, there may be pre-stored noises in the noise cancellation system (100) based on the user's residential area. For example, if the user is living near a railway station or school, the related noises are classified and stored. If a new type of noise is recognized which is not classified, the classification of sound is done automatically. The noise cancellation device (100) notifies the user on the user device about the new incoming noise. The incoming new sound wave may be cancelled or reduced as per the user requirement.

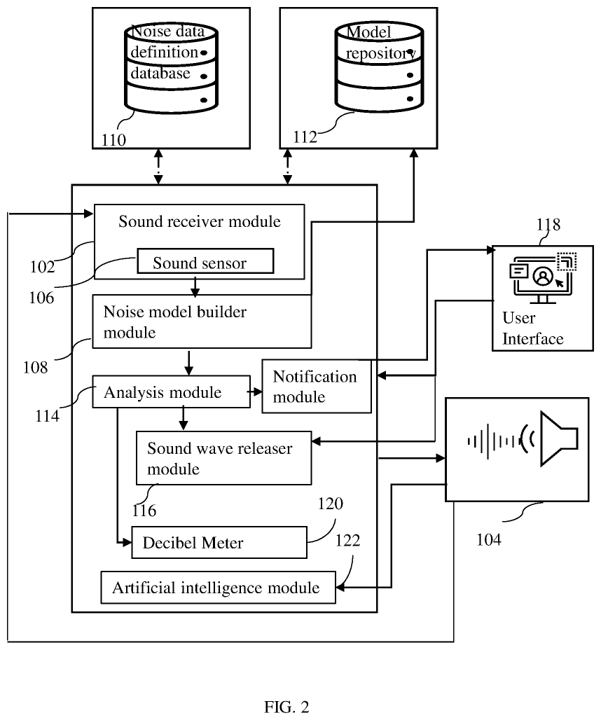

FIG. 2 is a block diagram representing another embodiment of the noise cancellation system (100) of FIG. 1 in accordance with an embodiment of the present disclosure. The noise cancellation system (100) for cancelling noise by releasing sound waves to distort a path of sound particles. The noise cancellation system (100) includes a sound receiver module (102), a noise model builder module (108), an analysis module (114), a sound wave releaser module (116), and a user interface (118). The sound receiver module (102) positioned at a source (104) of external noise entry and configured to receive a noise from an external uncontrolled noise source (104). The sound receiver module (102) comprises a sound sensor (106) for recording the received noise from the external uncontrolled noise source (104).

In one embodiment, the noise cancellation system includes a decibel meter (120) operatively coupled with the analysis module (114) and configured to record a residual sound after cancellation. The residual sound excludes human voices and speech. In one embodiment, the intensity of the noise is calculated on the decibel meter (120) and then controlled by the user interface (118). In one embodiment, the noise cancellation system (100) includes an artificial intelligence module (122) configured to store a plurality of artificial intelligence models and a plurality of machine learning models. The plurality of sound wave data is trained by a machine learning model of the plurality of machine learning models. Also, in one embodiment, the noise cancellation system (100) includes a notification module (124) configured to notify the user about an emergency based on the analysed noise. Yet in one embodiment, the noise cancellation system (100) is configured to be installed in a digital device, wherein the expected noise is received. In one embodiment, the noise cancellation system (100) may be installed to provide a service to various audio devices such as Bluetooth audio devices, sound bar, headphones, EarPods, and the like.

In one embodiment, the user interface (118) is enabled with artificial intelligence for displaying the intensity of the stored recorded noise, wherein the display enables the user to control the intensity of the noise cancellation. In another embodiment, the data of frequently incoming noises that are stored in the repository (112) are available at the noise cancellation system (100) to enhance the user experience.

In one embodiment, the noise cancellation device (100) is able to control multiple types of noises on a busy day. In one embodiment, the noise cancellation system (100) is able to identify known noises such as noise of railway, aeroplanes, and the like which are prestored in the system based on the user location. In another embodiment, the noise cancellation system (100) also identifies unknown noises which are not stored in the database (110) of the system. In one embodiment, an edge deployment of the known noises may be done from cloud to devices. In one embodiment, examples of the multiple types of noises are as follows:
Continuous Noise: Continuous noise comes from objects or machines that run without interruption. These noises are noticeable and occur all around in the environment. For example: In a car, a continuous noise is audible from the engine.
Intermittent Noise: Intermittent noises are infrequent but regular in your daily life. They come from loud bursts that may be noticeable but are not surprised by. For example: A person living near an airport may hear planes taking off and landing all the time. It is a loud noise, but he is not surprised by it.
Impulsive Noise: An impulsive noise is not regularly scheduled or recognized. Instead, it is like a surprising burst or a disturbing sound. For example: When a waiter dropping a plate, the restaurant generally calms down a little as people look around for the source (104) of the noise.
Low-Frequency Noise: A low-frequency noise comes from objects in the environment in everyday life. It makes a seemingly silent room still register sound levels around 30-40 decibels. For example: In an office setting, noise comes from a heating or ventilation system or in a home, the noise comes from the ticking of a clock.
Hybrid Noise: Hybrid Noise could be the combination of one or more of the above four types. It is also a new type of noise that gets classified in the future using Artificial Intelligence (AI) Annotation & Classification methods. The AI annotation automatically identifies and labels objects in images, videos, and text. The classification method enables annotating an entire image.

In one embodiment, the noise cancellation system (100) includes a command module. The command module is configured to command with a voice-enabled- instruction. In one embodiment, the instructions may be “reduce the noise”, “nullify the noise”, “annotate the noise”, and the like.

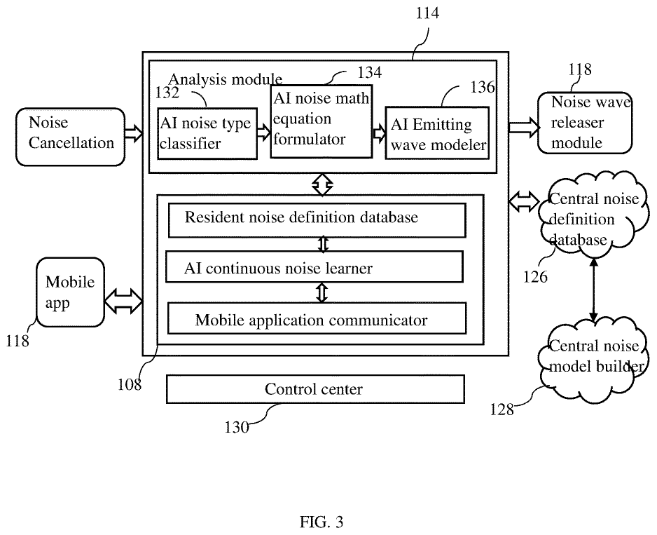

FIG. 3 is a block diagram representing an exemplary embodiment of an architecture of the noise cancellation system of FIG. 1 in accordance with an embodiment of the present disclosure. In one embodiment, a central noise model builder (128) builds a noise based of the central noise definition database (126). In one embodiment, if a new type of noise is recognized which is not classified, then the new noise is registered in the database (110). The classification of new noise is done automatically. The noise cancellation device (100) notifies the user on the user device about the new incoming noise. The incoming new sound wave may be cancelled or reduced as per the user requirement. In one embodiment, the noise cancellation system (100) includes a control central (130). In one embodiment, the center core (130) identifies the sound wave on the mobile application, the system notifies the user about the new sound wave and propose a corresponding inverted sound wave. The user if required the user may use the inverted sound wave proposed by an artificial intelligence algorithm of the mobile application to cancel the noise, then the inverted sound wave is released in the environment. The released inverted sound wave cancels the noise that is newly registered.

In one embodiment, the incoming noise is analysed by the analysis module (114). In one embodiment, the analysis module (114) includes AI noise type classifier (132), AI noise math equation formulator (134), AI Emitting wave modeler (136). The AI noise math equation formulator (134) forms an equation based on the noise received from the AI noise type classifier (132) and based on the equation AI emitting modeler (136) determines the amount of sound wave to be released.
The AI noise type classifier is an AI model that classifies the noise listened using Artificial Intelligence into one of the types of noises identified as per the knowledge of the Central Noise-Model database (126).
   The AI noise math equation or the AI model formulator process and creates math equations using the sound wave data from the AI Noise Type Classifier (132).
   The AI emitting wave modeler (136) inverses the math equation or the AI model created by the AI Noise Math Equation to produce the sound wave inverse to the original noise wave.
   The noise wave releaser module (118) converts is primarily a sound emitter of the inversed math equation created by The AI Emitting Wave Modeler back into an Inversed Sound Wave and emit that sound wave back into the surroundings to cancel the sound wave in the environment.

The noise model builder module (108) includes:
A resident noise definition database is a database of the most frequent noise recordings (5 or 10) which may store locally on the user system.
An AI Continuous New Noise Learner stands as an observer and records new noises, identified by the learner. This may also be used if the human would like to manually annotate any of the surrounding sounds as noises. This may act as a mechanism to learn new noises using Human-in-loop.
A mobile application interface communicator is the interface of communication between the home device, and the mobile app, where the mobile app itself is the interface that the end user uses to customize the requests to the device, such as changing the intensity of the cancellation, changing settings, and the like.
A Central Noise Definition Database (126) is a database in the cloud that stores every single observation recorded from all the individual devices.
   Periodically, a Central AI Noise Model Builder (128) creates different AI Models based on the noise data definitions available at the Central Noise Definition Database and stores the models back in the model repository (112) available in the Central Noise Definition Database (126). These models are eventually pushed to the home devices through Edge AI Deployment, to be used in the noise classification.

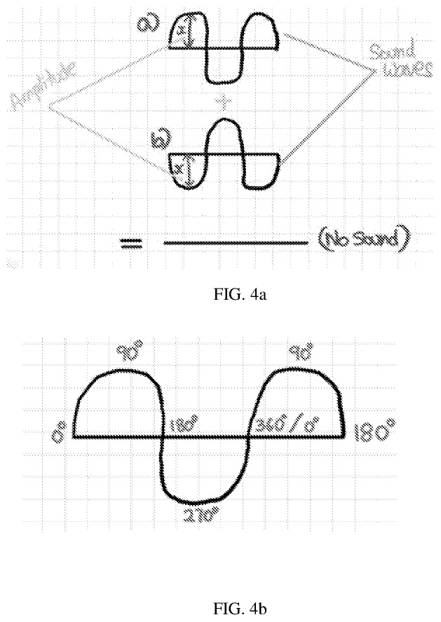

FIG. 4a is a graphical representation of an exemplary embodiment of the distortion of the sound wave of FIG. 1 in accordance with an embodiment of the present disclosure and FIG. 4b is a graph diagram representing an exemplary embodiment of the sound wave of FIG. 1 in accordance with an embodiment of the present disclosure. Considering a nonlimiting example of working of the noise cancellation system (100). When sound wave “a)” is being generated, the noise cancellation system (100) may comprehend, and identify the category of the sounds mentioned above. The sound wave releaser module (116) releases sound wave b). In this case, both the sound waves cancel out, and the user is left with silence.

In one embodiment, if the user does not want the sound to be canceled out totally, and wants to reduce the sound/noise in volume, then the user may convey that to the system through a user interface (118). The user interface (118) may have the option to change the request so that the user does not cancel out the sound wave but reduce the sound wave. The noise cancellation system (100) sends out a relatively low amplitude opposite to the sound wave, to cancel out only a small portion of the total noise, hence reducing the intensity of the sound wave. The intensity of the sound wave may be controlled, adjusted, and changed through the user device, which works seamlessly.

In one embodiment, artificial intelligence is also incorporated into the system, to perform tasks like sensing a prolonged intermittent noise and adjusting without giving a command and sensing any distinct types of noise. As the noise cancellation system (100) recognizes sounds and classifies them, it can also identify important sounds like a smoke alarm and the like. In a scenario, when the user is not at home, the system may send a notification to the user interface (118) saying that the system detected the sound of a smoke alarm. In one embodiment, the system may be used in intense situations such as a fire, it's training also would be with utmost quality, and there may not be any compromise in the quality of either the training data or the testing data, to ensure that the software does not send out a false alarm notification.

In one embodiment, if the user device identifies a sound wave and the user approves that sound wave to be controlled or cancelled, then the noise cancellation system, pushed a counter wave into the environment to cancel the noise. In one embodiment, the noise cancellation system (100) includes a sound listener microphone positioned at the source (104) of the noise, wherein the source (104) of the noise may be a window, a door, and the like.

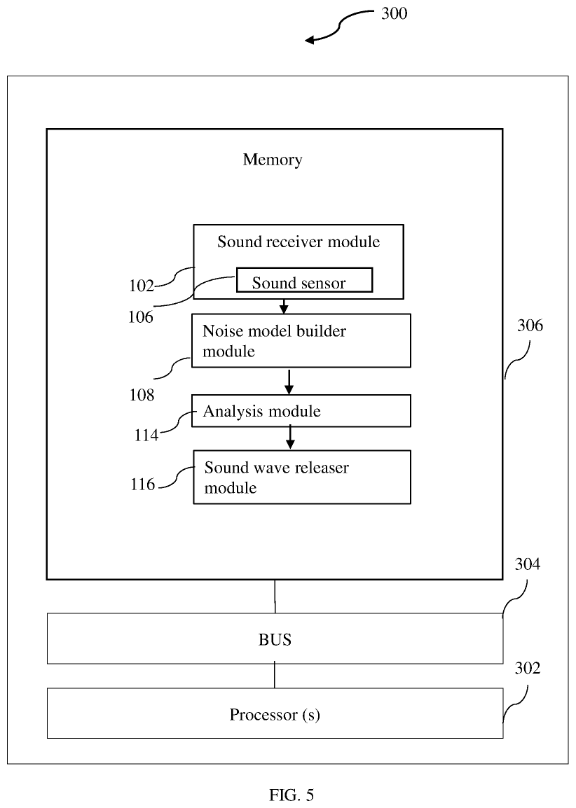

FIG. 5 is a block diagram of a computer or a server (300) for the noise cancellation system (100) in accordance with an embodiment of the present disclosure. In one embodiment, the computer may be a home device or a digital device. The server (300) includes a processor(s) (302), and memory (306) operatively coupled to the bus (304).

The processor(s) (302), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The bus (304) as used herein refers to be internal memory channels or computer network that is used to connect computer components and transfer data between them. The bus (304) includes a serial bus or a parallel bus, wherein the serial bus transmits data in a bit-serial format and the parallel bus transmits data across multiple wires. The bus (304) as used herein, may include but not limited to, a system bus, an internal bus, an external bus, an expansion bus, a frontside bus, a backside bus, and the like.

The memory (306) includes a plurality of subsystems and a plurality of modules stored in the form of an executable program which instructs the processor (302) to perform the method steps illustrated in FIG. 1. The memory (306) is substantially similar to the noise cancellation system (100) of FIG. 1. The memory (306) has submodules: a sound receiver module (102), a noise model builder module (108), an analysis module (114), and a sound wave releaser module (116).

The noise model builder module (108) is configured to build a plurality of artificial intelligence models based on a plurality of noise data definitions pre-stored in a database (110). The plurality of noise data definitions is a set of frequent noise recordings. The noise model builder module (108) stores the plurality of artificial intelligence models back in a model repository (112).

The analysis module (114) is operatively coupled with the sound receiver module (102) and the noise model builder module (108). The analysis module (114) is configured to classify and analyse the recorded noise by using the plurality of artificial intelligence models. The analysis of the recorded noise includes comparing the noise with a plurality of sound wave data stored in the database (110). The analysis module (114) is configured to determine an intensity of a recorded noise based on the analysis of the plurality of sound wave data.

The sound wave releaser module (116) is operatively coupled with the analysis module (114), wherein the sound wave releaser module (116) is configured to release a series of counter sound waves and an amplitude, based on the amplitude of the noise recorded by the sound sensor (106) thereby cancelling the noise received, wherein the series of counter sound waves distort the path of movement of a plurality of noise sound particles.

Computer memory elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. An executable program stored on any of the above-mentioned storage media may be executable by the processor(s) (302).

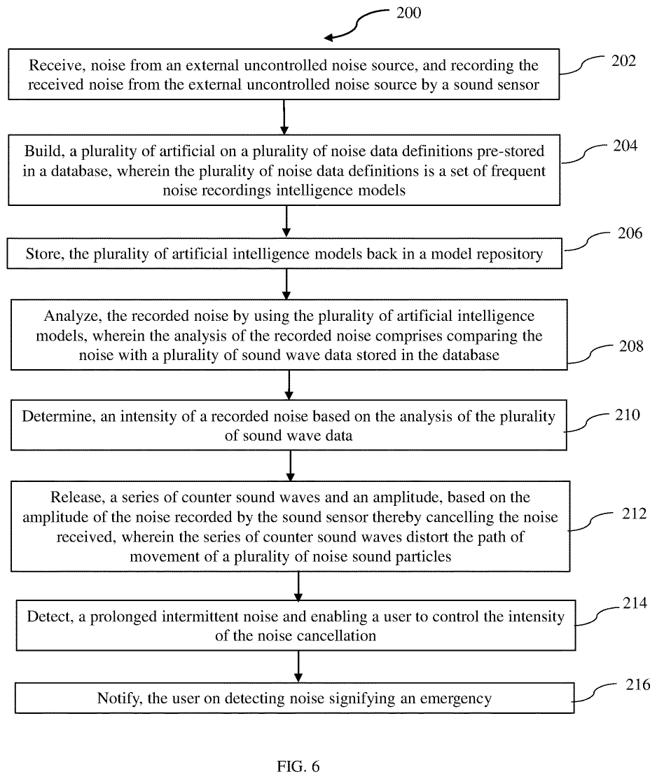

FIG. 6 is a flow chart representing steps involved in a method (200) for operating the noise cancellation system (100) in accordance with an embodiment of the present disclosure. The method (200) includes receiving, by a sound receiver module, noise from an external uncontrolled noise source, and recording the received noise from the external uncontrolled noise source by a sound sensor in step (202). The method also includes recording, by a decibel meter, a residual sound after cancellation. The residual sound excludes human voices and speech. The method also includes calculating, by the decibel meter, the intensity of the noise is and controlling by the user interface. The method also includes storing, by an artificial intelligence module, a plurality of artificial intelligence models and a plurality of machine learning models. The plurality of sound wave data is trained by a machine learning model of the plurality of machine learning models. The method also includes notifying, by a notification module, the user about an emergency based on the analysed noise. In one embodiment, the noise cancellation system is configured to be installed in a digital system, wherein the expected noise is received.

The method also includes building, by a noise model builder module, a plurality of artificial on a plurality of noise data definitions pre-stored in a database, wherein the plurality of noise data definitions is a set of frequent noise recordings intelligence models in step (204). The method also includes using, the database by the artificial intelligence model as a training set. In another embodiment, the recorded noise is stored in the user's local database.

Further, the method includes storing, by a noise model builder module, the plurality of artificial intelligence models back in a model repository in step (206). The method also includes updating, by the artificial intelligence module, the model repository, with the occurrences of the different noise data.

Furthermore, the method includes analyzing, by an analysis module, the recorded noise by using the plurality of artificial intelligence models, wherein the analysis of the recorded noise comprises comparing the noise with a plurality of sound wave data stored in the database in step (208).

Furthermore, the method includes determining, by the analysis module, an intensity of a recorded noise based on the analysis of the plurality of sound wave data in step (210). The method also includes analysing, the sound waves based on the database where the recorded sound waves of noise may be stored.

Furthermore, the method includes releasing, by a sound wave releaser module, a series of counter sound waves and an amplitude, based on the amplitude of the noise recorded by the sound sensor thereby cancelling the noise received, wherein the series of counter sound waves distort the path of movement of a plurality of noise sound particles in step (212).

Furthermore, the method includes detecting, by a user interface, a prolonged intermittent noise and enabling a user to control the intensity of the noise cancellation in step (214). The method also includes displaying, the intensity of the stored recorded noise, wherein the display enables the user to control the intensity of the noise cancellation.

Furthermore, the method includes notifying, by the user interface, the user of detecting noise signifying an emergency in step (216). The method also includes notifying, by using wireless communication. The method also includes notifying the user about an emergency and suggesting the user to control the noise cancelation.

In one embodiment, the steps for recognizing different sounds by the artificial intelligence module (122) are:
Recording, the sound by a sound recognition system that is identified through a sensor that may detect the sound. This step allows the model to create a foundation for the further processing of sounds, like classifying them into types of sound.
Analysing, the recordings of the sounds. This means that the recorded sounds are compared to the data the model which may be trained on. A better the training process and the higher quality of the data provides the faster and more accurate prediction.
providing, an output by interpreting what kind of the recorded sound wave is, and how intense it is using the decibel meter, so that to provide outputs of an appropriate sound wave. This system also stores the recorded sounds in a database (110), which it may later refer to similar sounds using the classification method to pinpoint the source (104) of the sound, the type of sound, and the like. This is useful for the system to stay up to date with the sounds and does not need to rely on the training data. The output may use the recorded sounds as a reference point.

Various embodiments of the present disclosure enable the user to hear clear sound by cancelling the uncontrolled environmental noise. The noise cancellation system as disclosed in the present disclosure reduces the environmental noise required. The present disclosure suppresses the uncomfortable, bulky, unsightly, or ineffective noise with user comfort. The system disclosed in the present disclosure does not have limited applicability. The system in the present disclosure is suitable for large spaces, even where there is low frequency or high frequency sounds such as machinery sounds. The noise cancellation system disclosed in the present disclosure enables the user to avoid the noise in critical medical conditions such as when the user can not wear headphone, bedridden patients, and the like. Further, the present system includes a large range of predictable and unpredictable frequencies.

Further, the noise cancellation system in the present disclosure does not cancel the noise by identifying an emergency noise such as a smoke alarm. The system disclosed in the present disclosure, is not restricted to the ears and can be placed freely in the open area. Also, the present system for noise cancellation may be controlled, adjusted, and changed through a wireless device. The wireless device may include a remote, a mobile phone, and the like. As the noise is fundamentally a sound wave, the noise cancellation system in the present disclosure cancels or reduce the noise even if the noise is not discovered. The noise cancellation system gets better as more customers purchases the systems. Due to AI the noise cancellation system learns and records more data because of the common cloud database. Every individual device may access the cloud database as the cloud database gets updated every time a new sound or noise pattern is recognized.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

What is claimed is:

1. An open-air noise cancellation system (100) for cancelling noise by releasing sound waves to counter and nullify a path of sound particles, wherein the noise cancellation system (100) comprises:
a sound receiver module (102) positioned at a source (104) of external noise entry and configured to receive a noise from an external uncontrolled noise source (104), wherein the sound receiver module (102) comprises a sound sensor (106) for recording the received noise from the external uncontrolled noise source (104);
a noise model builder module (108) configured to build a plurality of artificial intelligence models based on a plurality of noise data definitions pre-stored in a database (110),
wherein the plurality of noise data definitions is a set of frequent noise recordings, and
wherein the noise model builder module (108) stores the plurality of artificial intelligence models back in a model repository (112);
an analysis module (114) operatively coupled with the sound receiver module (102) and the noise model builder module (108), wherein the analysis module (114) is configured to:
classify and analyse the recorded noise by using the plurality of artificial intelligence models, wherein the analysis of the recorded noise comprises comparing the noise with a plurality of sound wave data stored in the database (110); and
determine an intensity of a recorded noise based on the analysis of the plurality of sound wave data;
a sound wave releaser module (116) operatively coupled with the analysis module (114), wherein the sound wave releaser module (116) is configured to:
release a series of counter sound waves and an amplitude, based on the amplitude of the noise recorded by the sound sensor (106) thereby cancelling the noise received, wherein the series of counter sound waves distort the path of movement of a plurality of noise sound particles; and
a user interface (118) operatively coupled with the analysis module (114) and the sound wave releaser module (116), wherein the user interface (118) is configured to:
detect a prolonged intermittent noise and enable a user to control the intensity of the noise cancellation; and
notify the user on detecting noise signifying an emergency.

2. The noise cancellation system (100) as claimed in claim 1, comprises a decibel meter (120) operatively coupled with the analysis module (114) and configured to record a residual sound after cancellation, wherein the residual sound excludes human voices and speech.

3. The noise cancellation system (100) as claimed in claim 2, wherein the intensity of the noise is calculated on the decibel meter (120) and then controlled by the user interface (118).

4. The noise cancellation system (100) as claimed in claim 1, comprises an artificial intelligence module (122) configured to store a plurality of artificial intelligence models and a plurality of machine learning models, wherein the plurality of sound wave data is trained by a machine learning model of the plurality of machine learning models.

5. The noise cancellation system (100) as claimed in claim 1, wherein the noise recorded is stored in a database (110) is subsequently used by the artificial intelligence model as a training set.

6. The noise cancellation system (100) as claimed in claim 1, wherein the recorded noise is stored in the user's local database.

7. The noise cancellation system (100) as claimed in claim 1, comprises a notification module (124) configured to notify the user about an emergency based on the analysed noise.

8. The noise cancellation system (100) as claimed in claim 1, is configured to be installed in a digital device, wherein the expected noise is received.

9. The noise cancellation system (100) as claimed in claim 1, wherein the user interface (118) is enabled with the artificial intelligence for displaying the intensity of the stored recorded noise, wherein the display enables the user to control the intensity of the noise cancellation.

10. A method (200) for operating an open-air noise cancellation system, wherein the method comprises:
receiving, by a sound receiver module, noise from an external uncontrolled noise source, and recording the received noise from the external uncontrolled noise source by a sound sensor; (202)
building, by a noise model builder module, a plurality of artificial on a plurality of noise data definitions pre-stored in a database, wherein the plurality of noise data definitions is a set of frequent noise recordings intelligence models; (204)
storing, by a noise model builder module, the plurality of artificial intelligence models back in a model repository; (206)
analyzing, by an analysis module, the recorded noise by using the plurality of artificial intelligence models, wherein the analysis of the recorded noise comprises comparing the noise with a plurality of sound wave data stored in the database; (208)
determining, by the analysis module, an intensity of a recorded noise based on the analysis of the plurality of sound wave data; (210) releasing, by a sound wave releaser module, a series of counter sound waves and an amplitude, based on the amplitude of the noise recorded by the sound sensor thereby cancelling the noise received, wherein the series of counter sound waves distort the path of movement of a plurality of noise sound particles; (212)
detecting, by a user interface, a prolonged intermittent noise and enabling a user to control the intensity of the noise cancellation; (214) and
notifying, by the user interface, the user on detecting noise signifying an emergency. (216)
